(19) United States
(12) Patent Application Publication
(10) Pub. No.: US 2003/0184045 A1
(43) Pub. Date: Oct. 2, 2003

(54) Lift truck

(76) Inventor: Philip Thomas Callan, Worcestershire (GB)

Correspondence Address: Lisa A. Bongiovi, 55 Griffin South Road, Bloomfield, CT, 06002, US

(21) Appl. No.: 10/396,524

(22) Filed: Mar. 25, 2003

(30) Foreign Application Priority Data
Mar. 27, 2002 (GB) 0207352.6

(51) Int. Cl. B62D 12/00

(52) U.S. Cl. 280/400; 187/222; 180/418

(57) ABSTRACT

A lift truck has a wheeled rear section to which is pivotally connected a wheeled front section, with one of the sections being drivable, in use. The front section, which has lifting forks, is pivoted to an extended length arm at the front of the rear section, to allow the front section to pivot relative the rear section, to at least one side thereof, by an angle substantially greater than 90°. Part of the rear section can be relieved to permit said pivoting.

This invention relates to articulated vehicles, in particular an articulated forklift truck.

Articulated forklift trucks are well known, comprising a rear section which carries, for example, an operator's cabin and drive motor, the rear section being connected by a vertical pivot axis to a front section which carries a pair of lifting forks. Such an articulated truck is commonly used in warehouses, as the articulated construction allows it to operate in narrower aisles than conventional forklift trucks. The articulation allows the front section, and thus the load carried, in use, by the forks, to rotate relative to the rear section. This allows entry of the front section into storage bays.

It is commonly known for the front load bearing section of such a truck to be able to articulate through an angle of approximately 90°, relative to the straight ahead state of the truck where the front and rear sections are in longitudinal alignment. Generally the degree of articulation is limited by the physical constraints of the truck design.

Although this known articulation provides a truck which is more versatile than an equivalent non-articulated truck, the degree of articulation referred to does not allow the pallet load carried by the forks to enter tight locations perpendicular to the racking of the aisles. The truck driver is thus required to drive the truck when fully articulated. This results in the load moving non-perpendicularly to the racking, resulting in the need for wider aisles or for greater clearance between pallet loads. Alternatively the use of an additional sideshift function is required, thereby slowing the operation and increasing complexity.

An object of the invention is to overcome the above-mentioned problem.

According to the invention an articulated vehicle comprises a wheeled front section, a wheeled rear section, at least one of the front and rear sections being drivable, in use, the front and rear sections being pivotally connected at a vertical axis for relative pivotal movement between a straight ahead position, where the front and rear sections are in line, to a position where one of the sections is at an angle to the other section, the maximum possible angle being substantially greater than 90°.

Preferably the front section carries a pair of lifting forks and is pivotable through an angle substantially greater than 90°, relative to the rear section, from said straight ahead position. Desirably the pivot axis is positioned further forward of the front end of the rear section than with pior art articulated trucks.

The invention will now be described, by way of example, with reference to the accompanying drawings, in which:

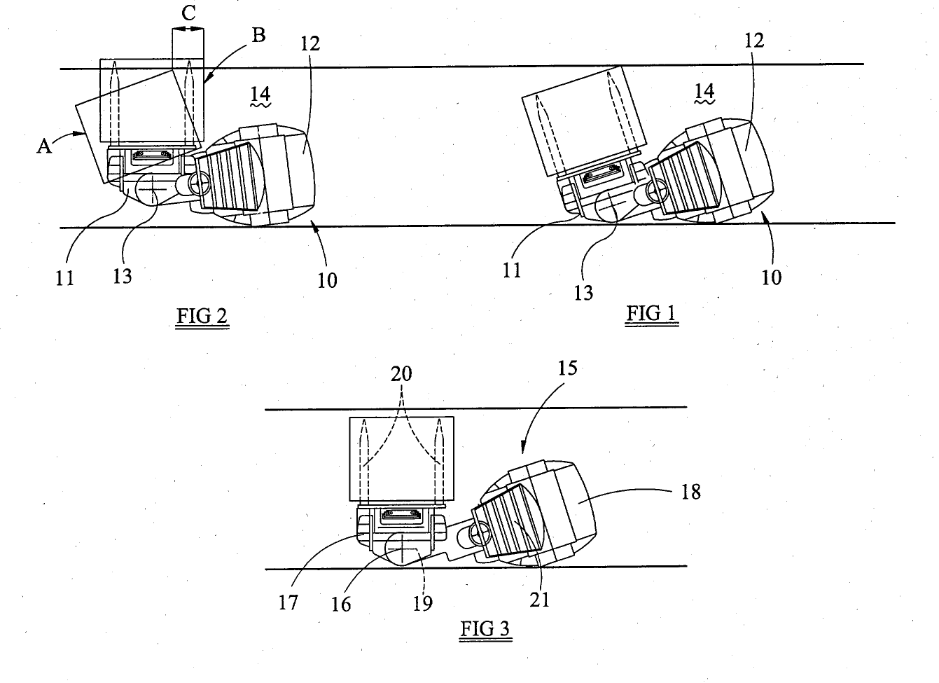

FIG. 1 is a schematic plan view of a known articulated fork lift truck operating in a narrow aisle before the load is stowed in a side space of the racking of the aisle,

FIG. 2 is a view like FIG. 1, but with the load being stowed, and

FIG. 3 is a view equivalent to FIG. 1, for a truck constituting a vehicle of the invention.

FIG. 1 shows a prior art lift truck 10, having front and rear sections 11, 12 respectively articulated about a vertical pivot axis 13, operating in a narrow aisle 14 between parallel rows of racking (not shown).

FIG. 1 shows the front section 11 turned through 90° to the rear section. It is not possible to turn the front section by more than 90°, due to the abutment of part of the front section against part of the truck rear section (chassis) in the position shown.

As can be seen from FIG. 1, however, the 90° articulation does not allow the pallet load to enter a tight location perpendicular to the racking. As is thus apparent from FIG. 2, the truck driver is thus required to drive the truck with the front section at 90° full articulation to the rear section, to move from the FIG. 1 position to the FIG. 2 ‘load stowed’ position.

In FIG. 2, arrow A shows the position of the load as it starts to enter the racking at one side of the aisle, whilst arrow B shows the position of the load when it is perpendicular to the racking after the driver has driven the truck at full articulation. The space thus needed between the pallets of the racking to allow for the ‘swing’ illustrated is shown at C.

As mentioned in the introduction, with this prior art truck the movement of the load results in the need for wider aisles or greater clearance between pallet loads. Another alternative solution is the provision of an additional sideshift function, which as stated, would slow the operation and increase its complexity.

FIG. 3 shows a forklift truck 15 constituting an articulated vehicle of the invention. As compared to the known truck of FIGS. 1 and 2, it can be seen that the articulation pivot axis 16 between the front and rear sections 17, 18 respectively is on an extended arm 19, i.e. compared to the equivalent arm of the prior art truck of FIGS. 1 and 2 it is of increased length so as to space the pivot axis further from the front end of the rear section of the truck. The pivot axis is at or adjacent a forward end of the arm. This allows pivoting of the front section, to either side of the rear section, through an angle substantially greater than 90°. If necessary this increased spacing of the pivot can be in conjunction with part of the rear section being relieved to permit turning of the front section through said angle substantially greater than 90°. Alternatively the increased angle of turning substantially beyond 90° could be permitted by way only of such relieving of the rear section, i.e. without the increased spacing of the pivot axis from the rear section.

Whilst the truck is preferably arranged to permit turning of the front section through a maximum angle of substantially greater than 90° to both sides of the truck, i.e. to both sides of the aligned straight ahead state of the truck, it could be arranged in an alternative construction to be turned through an angle substantially greater than 90°, at one side only.

With the present invention, the design of vertical pivot which allows substantially greater articulation than ±90° permits the pallet load to enter the desired location perpendicularly to the pallet rack, and hence offers the use of narrower aisles and greater use of storage space. Operation can thus be quicker, leading to greater productivity. The sideshift option is no longer needed, saving cost, reducing complexity and increasing operating speed.

As will be understood, the truck of the illustrated embodiment will have its front and rear sections appropriately wheeled, with appropriate power/drive means at one or both thereof. The lifting forks 20 would preferably be raised and lowered on a mast carried by the front section 17, so that the mast with the forks thereon can be pivoted through an angle substantially greater than 90°. Typically the maximum angle of turning is approximately 105°, but by appropriate design, it could be greater than that.

Other conventional features would be provided as expected, i.e. an operator's cabin 21, but form no part of the present invention.

1. An articulated vehicle comprising a wheeled front section, a wheeled rear section, at least one of the front and rear sections being drivable, in use, the front and rear sections being pivotally connected at a vertical axis for relative pivotal movement between a straight ahead position, where the front and rear sections are in a line, to a position where one of the sections is at an angle to the other section, the maximum possible angle being substantially greater than 90°.

2. A vehicle as claimed in claim 1, wherein the front section carries a pair of lifting forks and is pivotable through an angle substantially greater than 90°, relative to the rear section, from said straight ahead position.

3. A vehicle as claimed in claim 2, wherein the pivoting through an angle substantially greater than 90° is permitted by the length of an arm extending from the rear section, at or adjacent a forward end of which arm the front section is pivoted to the rear section.

4. A vehicle as claimed in claim 3, wherein part of the rear section is relieved to permit said pivoting of the front section through said angle substantially greater than 90°, in use.

5. A vehicle as claimed in claim 1, wherein part of the rear section is relieved to permit said pivoting of the front section through said angle substantially greater than 90°, in use.

6. A vehicle as claimed in claim 1, wherein the pivoting of front section relative to the rear section, or vice versa, through an angle substantially greater than 90°, is possible to one side only.

7. A vehicle as claimed in claim 1, wherein said angle substantially greater than 90° is at least 105°.
